(19) United States
(12) Patent Application Publication
(10) Pub. No.: US 2021/0065276 A1
(43) Pub. Date: Mar. 4, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Masahiro SATO, Kanagawa (JP); Janmajay SINGH, Kanagawa (JP); Sho TAKEMORI, Kanagawa (JP); Takashi SONODA, Kanagawa (JP); Qian ZHANG, Kanagawa (JP); Tomoko OHKUMA, Kanagawa (JP)

(73) Assignee: FUJI XEROX CO., LTD., Tokyo (JP)

(21) Appl. No.: 16/776,508

(22) Filed: Jan. 30, 2020

(30) Foreign Application Priority Data
Aug. 28, 2019 (JP) 2019-156045

(51) Int. Cl. G06Q 30/06; G06N 20/00; G06Q 30/02

(52) U.S. Cl. CPC G06Q 30/0631; G06N 20/00; G06Q 30/0255; G06Q 30/0623; G06Q 30/0641

(57) ABSTRACT

An information processing apparatus includes a memory and a processor. The memory stores, for each object judged by a user whether to select the object, a selection history indicating whether the user has selected the object and a recommendation history indicating whether the object has been recommended to the user. The processor reads information from the memory. The processor is configured to conduct machine learning for estimating an effect of recommending each object from the selection history and the recommendation history, and to output, based on a result of the machine learning, information concerning an object that is predicted to be more likely to be selected by the user as a result of being recommended so as to satisfy a predetermined possibility level or higher.

### CROSS-REFERENCE TO RELATED APPLICATIONS

This application is based on and claims priority under 35 USC 119 from Japanese Patent Application No. 2019-156045 filed Aug. 28, 2019.

### BACKGROUND

### (i) Technical Field

The present disclosure relates to an information processing apparatus and a non-transitory computer readable medium.

### (ii) Related Art

An information processing apparatus which extracts one or more objects from multiple objects and recommend them to a user is provided. For example, virtual stores and video streaming sites on the internet may recommend their product items and content to encourage users to buy them or view and listen to them. A point of sale (POS) system used in a brick-and-motor store, such as a retail store, may extract its product items to be advertised by using flyers, for example, based on the consumer trend.

Japanese Patent No. 5277307 discloses a method for determining whether to recommend an item to a user in accordance with whether this item is more similar to an item which has been purchased by the user as a result of being recommended or an item which has not been purchased by the user as a result of being recommended.

Japanese Unexamined Patent Application Publication No. 2017-211699 discloses an approach to recommending an item which is far more purchased when it is recommended and which is far less purchased when it is not recommended.

### SUMMARY

It is known that the effect of recommending items is different among items. For some items, users are discouraged from buying them when they are recommended. For some items, users are determined to buy them regardless of whether or not they are recommended.

Aspects of non-limiting embodiments of the present disclosure relate to obtaining information concerning an object which is predicted to be more likely to be selected by a user as a result of being recommended.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a memory and a processor. The memory stores, for each object judged by a user whether to select the object, a selection history indicating whether the user has selected the object and a recommendation history indicating whether the object has been recommended to the user. The processor reads information from the memory. The processor is configured to conduct machine learning for estimating an effect of recommending each object from the selection history and the recommendation history, and to output, based on a result of the machine learning, information concerning an object that is predicted to be more likely to be selected by the user as a result of being recommended so as to satisfy a predetermined possibility level or higher.

### BRIEF DESCRIPTION OF THE DRAWINGS

An exemplary embodiment of the present disclosure will be described in detail based on the following figures, wherein:

FIG. 1 illustrates an example of the overall configuration of an information processing system;

FIG. 2 illustrates an example of the configuration of an information processing apparatus;

FIG. 3 illustrates an example of a history database (DB);

FIG. 4 is a table for explaining object groups into which objects are categorized;

FIG. 5 illustrates an example of characteristic information;

FIG. 6 is a flowchart illustrating an example of an object categorizing operation executed by the information processing apparatus;

FIG. 7 is a flowchart illustrating an example of a learning operation executed by the information processing apparatus;

FIG. 8 is a flowchart illustrating an example of a predicting operation executed by the information processing apparatus;

FIG. 9 illustrates an example of a history DB;

FIG. 10 illustrates an example of a history table during a period different from the period of a history table in FIG. 9;

FIGS. 11A and 11B illustrate examples of characteristic information;

FIG. 12 is a table illustrating a result of categorizing objects judged by a user whether to select them during different periods; and

FIG. 13 is a table illustrating a combination of object groups and a rating therefor.

### DETAILED DESCRIPTION

### (Configuration of Information Processing System)

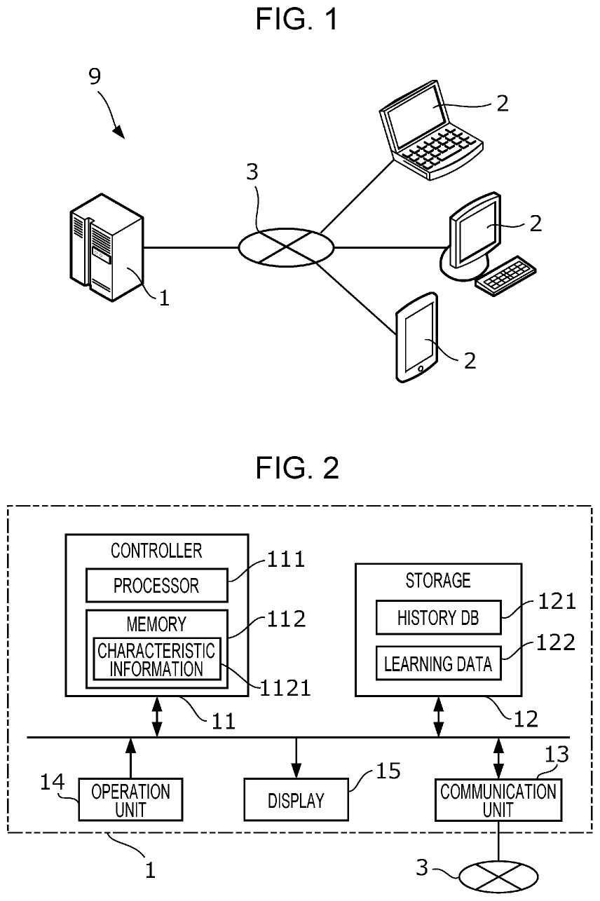

FIG. 1 illustrates an example of the overall configuration of an information processing system 9. The information processing system 9 includes an information processing apparatus 1, terminals 2, and a communication network 3 which connects the information processing apparatus 1 and the terminals 2 so that they can communicate with each other.

The communication network 3 may be a local area network (LAN), a wide area network (WAN), the internet, or a combination thereof.

The terminals 2 are information processing terminals, such as personal computers (PCs), smartphones, slate PCs, and tablet PCs. The terminals 2 send and receive information to and from a server device (not shown), for example, connected to the communication network 3. The server device is an information processing apparatus that runs a virtual store using the internet. In response to a request for an item from a user of a terminal 2, the server device sends data concerning the image and the price of the item, for example, and receives an order for the item from the user.

The server device also extracts one or more items from among items handled by the virtual store and sends the images of the extracted items to a terminal 2 so as to advertise the items to the user of the terminal 2.

In this case, each of the advertised items is an example of an object to be judged by a user whether to select it. Advertising an item to a user is an example of recommending an item to a user as an object. A user purchasing an item is an example of a user selecting an item as an object.

The above-described item may be an individual item represented by the name or the number, or may be the category of the item, such as milk, fresh food, stationery.

The information processing apparatus 1 monitors items being presented and advertised by the server device and items being viewed and purchased by users using the terminals 2, and stores histories concerning such items. A user views data concerning the images and prices of items sent from the server device. The data sent from the server device includes data concerning an item searched by the server device in response to a request from a user. The data sent from the server device also includes data concerning an item recommended by the server device without a user request.

If a user has purchased a certain item before the lapse of a predetermined time after viewing data concerning this item, the information processing apparatus 1 determines that this item has been selected. If the user has not purchased a certain item before the lapse of the predetermined time, the information processing apparatus 1 determines that this item has not been selected.

Viewing and purchasing of items by users using the terminals 2 may be monitored by a device other than the information processing apparatus 1 if the information processing apparatus 1 is able to obtain the monitoring results.

Although the single information processing apparatus 1 and the single communication network 3 are shown in FIG. 1, plural information processing apparatuses 1 and plural communication networks 3 may be included in the information processing system 9. Although three terminals 2 are shown in FIG. 1, only one terminal 2 may be disposed or any multiple number of terminals 2 may be disposed.

### (Configuration of Information Processing Apparatus)

FIG. 2 illustrates an example of the configuration of the information processing apparatus 1. As shown in FIG. 2, the information processing apparatus 1 includes a controller 11, a storage 12, a communication unit 13, an operation unit 14, and a display 15. These elements are connected to one another via a bus, for example, so that they can communicate with one another.

The controller 11 includes a processor 111 and a memory 112. The controller 11 may also include a read only memory (ROM). The processor 111 reads a computer program (will also simply be called a program) stored in the ROM or the storage 12 into the memory 112 and executes the read program so as to control the individual elements of the information processing apparatus 1. The processor 111 is a central processing unit (CPU), for example. The memory 112 is a random access memory (RAM), for example.

The communication unit 13 is a communication circuit connected to the communication network 3 via a wired or a wireless medium. By using the communication unit 13, the information processing apparatus 1 sends and receives information to and from the terminals 2, the server device, and other external devices (not shown) connected to the communication network 3.

The operation unit 14 includes an operator for giving various instructions, such as operation buttons, a keyboard, a touchscreen, and a mouse. The operation unit 14 receives an operation and sends a signal to the controller 11 in accordance with the content of operation. Examples of the operation are pressing the keyboard and gesture performed on the touchscreen.

The display 15 includes a display screen, such as a liquid crystal display, and displays images under the control of the controller 11. A transparent touchscreen of the operation unit 14 may be superposed on the display screen. The provision of the operation unit 14 and the display 15 for the information processing apparatus 1 may be omitted.

The storage 12 is a storage unit, such as a solid-state drive and a hard disk drive, and stores an operating system (OS) and various programs and data read by the processor 111.

The storage 12 includes a history database (DB) 121 and learning data 122. The history DB 121 is a database storing a selection history and a recommendation history for each object judged by the user of a terminal 2 whether to select it. The selection history is a history indicating whether the user has selected the object. The recommendation history is a history indicating whether the object has been recommended to the user.

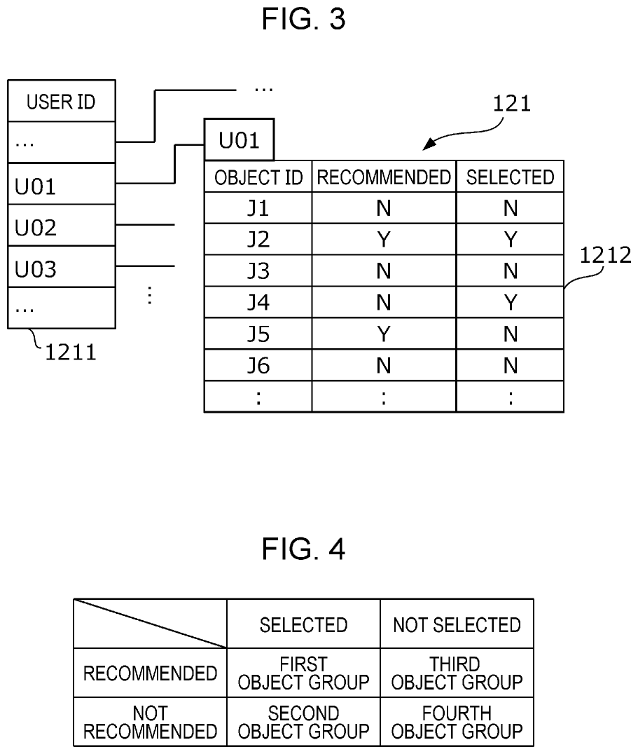

FIG. 3 illustrates an example of the history DB 121. The history DB 121 has a user list 1211 and a history table 1212, as shown in FIG. 3. The user list 1211 is a list storing user IDs, which are identification information for identifying individual users. The history table 1212 is a table storing, for each user ID stored in the user list 1211, a recommendation history and a selection history concerning objects that are judged by the user identified by a certain user ID whether to select the objects after viewing them.

For example, the history table 1212 shown in FIG. 3 indicates the recommendation history and the selection history concerning the objects viewed by the user identified by the user ID “U01”. “Object ID” in the history table 1212 is identification information for identifying an object, such as an item.

“Recommended” in the history table 1212 is information indicating whether the object identified by a certain object ID has been recommended to the user of the user ID “U01” by the server device, for example. If “Y” is input in the “recommended” field, the object has been recommended. If “N” is input in the “recommended” field, the object has not been recommended.

“Selected” in the history table 1212 is information indicating whether the user of the user ID “U01” has selected the object identified by a certain object ID. If “Y” is input in the “selected” field, the user has selected the object. If “N” is input in the “selected” field, the user has not selected the object.

The processor 111 reads the history DB 121 from the storage 12 and copies the entirety or part of the history DB 121 into the memory 112. The processor 111 also reads the selection history and the recommendation history included in the history DB 121 copied into the memory 112, and generates characteristic information 1121 based on the selection history and the recommendation history. The characteristic information 1121 is information indicating the characteristic of a certain user about the selection of objects.

Each of the storage 12 and the memory 112 is an example of a memory storing, for each object judged by a user whether to select it, a selection history indicating whether the user has selected the object and a recommendation history whether this object has been recommended to this user. The processor 111 is an example of a processor that reads information from this memory.

The processor 111 generates the characteristic information 1121, based on the selection history and the recommendation history read from the history DB 121, and stores the generated characteristic information 1121 in the memory 112. More specifically, the processor 111 categorizes each of the objects judged by the user whether to select it, based on a combination of regarding whether the object has been selected and whether the object has been recommended.

FIG. 4 is a table for explaining object groups into which objects are categorized. Objects judged by users whether to select them after viewing them, for example, are categorized into four object groups, that is, first through fourth object groups, based on a combination of regarding whether objects have been selected and whether objects have been recommended.

The first object group is a recommended/selected object group. An object recommended to a user and selected by the user is categorized as the first object group.

The second object group is a not-recommended/selected object group. An object that is not recommended to a user and is selected by the user is categorized as the second object group.

The third object group is a recommended/not-selected object group. An object that is recommended to a user and is not selected by the user is categorized as the third object group.

The fourth object group is a not-recommended/not-selected object group. An object that is not recommended to a user and is not selected by the user is categorized as the fourth object group.

An object that is not selected if it is not recommended and that is selected if it is recommended (such an object will be called an object α) is an object that a user is encouraged to select when it is recommended. That is, the object α is “an object that is predicted to be more likely to be selected by a user as a result of being recommended”.

For an object categorized as the first object group (recommended/selected), it is unknown whether the object is selected when it is not recommended. It is however at least possible that the first object group includes the object α. The processor 111 thus rates an object categorized as the first object group as a positive example.

For an object categorized as the fourth object group (not-recommended/not-selected), it is unknown whether the object is selected when it is recommended. It is however at least possible that the fourth object group includes the object α. The processor ill thus rates an object categorized as the fourth object group as a positive example. Among numerous objects, recommended objects are typically fewer than those that are not recommended. That is, the total number of objects in the first object group tends to be smaller than that in the fourth object group. When rating objects in the fourth object group as positive examples, a smaller weighting coefficient is applied to these objects than that to objects in the first object group.

An object that is selected when it is not recommended and is not selected when it is recommended (such an object will be called an object β) is an object that a user is discouraged from selecting when it is recommended. That is, the object β is “an object that is predicted to be less likely to be selected by a user as a result of being recommended”.

For an object categorized as the second object group (not-recommended/selected), it is unknown whether the object is selected when it is recommended. It is however at least possible that the second object group includes the object β. The processor 111 thus rates an object categorized as the second object group as a negative example.

For an object categorized as the third object group (recommended/not-selected), it is unknown whether it is selected when it is not recommended. It is however at least possible that the third object group includes the object β. The processor 111 thus rates an object categorized as the third object group as a negative example.

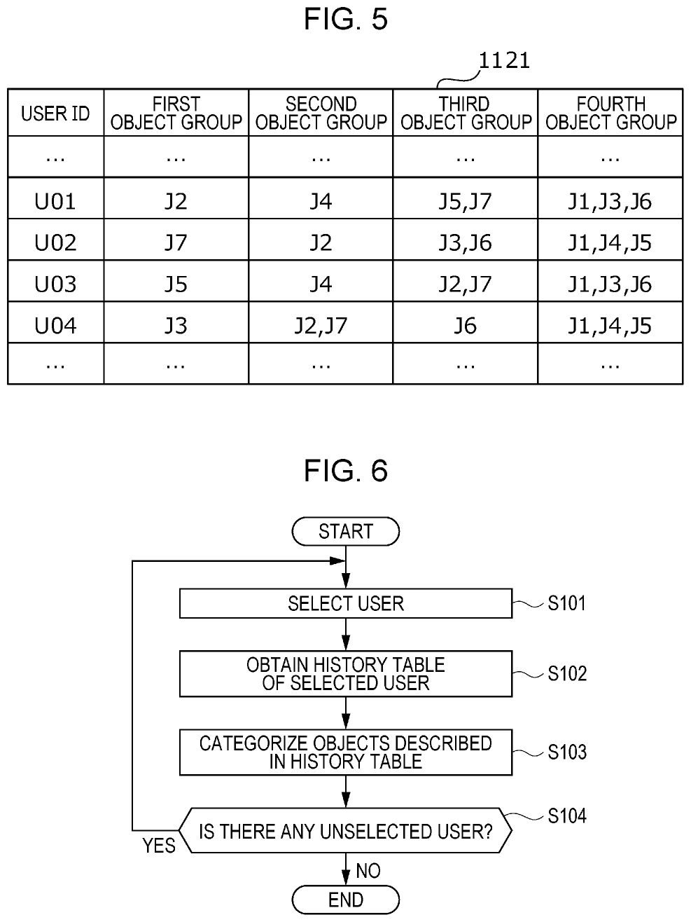

FIG. 5 illustrates an example of the characteristic information 1121. The processor 111 reads the history DB 121 copied into the memory 112 and categorizes, for each user, the objects viewed by the user into the four object groups so as to generate the characteristic information 1121 shown in FIG. 5.

In the characteristic information 1121, concerning the user ID “U01”, for example, the object ID “J2” is categorized as the first object group, the object ID “J4” is categorized as the second object group, the object IDs “J5” and “J7” are categorized as the third object group, and the object IDs “J1”, J3″, and “J6” are categorized as the fourth object group.

The processor 111 uses collaborative filtering to analyze the characteristic information 1121 and to allocate users for which objects are similarly categorized to the same group. For example, for both the user identified by the user ID “U01” and the user identified by the user ID “U03”, the object ID “J4” is categorized as the second object group and the object IDs “J1”, “J3”, and “J6” are categorized as the fourth object group. The processor 111 thus identifies that the users of the user IDs “U01” and “U03” resemble each other.

When analyzing the characteristic information 1121, instead of individually distinguishing the object groups from each other, the processor 111 may distinguish the object groups in accordance with whether they are rated as a positive example or a negative example. For example, the processor 111 may extract multiple users for which the same object is categorized as the second or third object group rated as a negative example, and then allocate such users to a common group. In this case, the processor 111 disregards whether the same object is categorized as the second or third object group.

The learning data 122 stored in the storage 12 includes data concerning the features of objects and those of users, for example. The feature is represented by a vector or a matrix including multiple elements. The processor 111 initializes the features of objects and those of users by random numbers, for example, and updates the features based on the characteristic information 1121. When the difference between the updated feature and the previous feature becomes smaller than a threshold, the processor ill stores the updated feature in the storage 12 as the learning data 122. Updating the learning data 122 by the processor 111 is conducting machine learning for estimating the effect of recommending objects. That is, the processor 111 is an example of a processor that conducts machine learning for estimating the effect of recommending each object from the above-described selection history and recommendation history.

The processor 111 then reads the learning data 122 stored in the storage 12, predicts objects to be recommended to a user, based on the results of machine learning, and outputs information concerning the predicted objects. “Objects to be recommended to a user” are objects that are predicted to be more likely to be selected by a user as a result of being recommended so as to satisfy a predetermined possibility level or higher. The predetermined possibility level may be a relative level based on the ranking of objects, such as the highest three objects in the ranking, or may be an absolute value, such as the numerical value, which serves an indicator of the possibility of an object being selected, being higher than or equal to a threshold. The processor 111 is an example of a processor that outputs, based on the result of machine learning, information concerning an object that is predicted to be more likely to be selected by a user as a result of being recommended so as to satisfy a predetermined possibility level or higher.

### (Operation of Information Processing Apparatus)

### (Categorizing)

FIG. 6 is a flowchart illustrating an example of the object categorizing operation executed by the information processing apparatus 1. In step S101, the processor 111 of the controller 11 reads the user list 1211 of the history DB 121 from the storage 12 and selects a user ID described in the user list 1211.

Then, in step S102, the processor 111 obtains the history table 1212 of the user identified by the user ID selected in step S101 from the history DB 121 stored in the storage 12. In step S103, the processor 111 categorizes the objects identified by the object IDs described in the history table 1212 into the above-described four object groups. The result of categorizing the objects is stored in the memory 112 as the characteristic information 1121.

The processor 111 judges in step S104 whether there is any unselected user in the user list 1211. If there is any unselected user (YES in step S104), the processor 111 returns to step S101. If there is no unselected user in the user list 1211 (NO in step S104), the processor 111 completes this processing. As a result of executing the processing in FIG. 6, the characteristic information 1121 is generated and stored in the memory 112.

### (Learning)

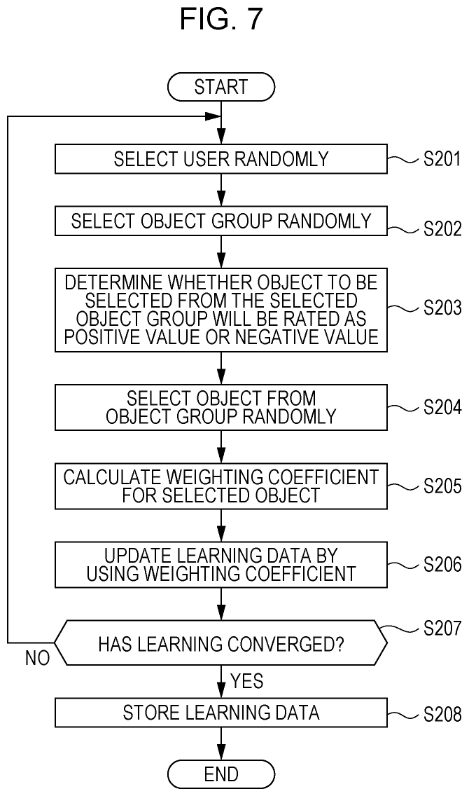

FIG. 7 is a flowchart illustrating an example of the learning operation executed by the information processing apparatus 1. The processor 111 of the controller 11 conducts machine learning for estimating the effect of recommending objects. In step S201, the processor 111 randomly selects one of the multiple users. In step S202, the processor 111 randomly selects one of the four object groups.

Then, in step S203, the processor 111 determines whether an object to be randomly selected from the selected object group will be rated as a positive example or a negative example in accordance with the object group.

For example, if the selected object group is the first object group, the processor 111 determines that an object to be randomly selected from the first object group will be rated as a positive example, as previously determined.

If the selected object group is the second object group, the processor 111 determines that an object to be randomly selected from the second object group will be rated as a negative example, as previously determined.

That is, the processor 111 is an example of a processor that categorizes objects into plural object groups including a first object group and a second object group and rates the first object group as a positive example and the second object group as a negative example, as machine learning for estimating the effect of recommending objects. The first object group is an object group which is recommended to a user and is selected by the user. The second object group is an object group that is not recommended to a user and is selected by the user. As a result of executing this operation, the processor 111 excludes objects that are likely to be selected even without recommendation, that is, an object that may be a necessary item for a user, from a group of objects to be recommended to this user.

If the selected object group is the third object group, the processor 111 determines that an object to be randomly selected from the third object group will be rated as a negative example, as previously determined.

That is, the processor ill is an example of a processor that categorizes objects into plural object groups including a third object group and rates the third object group as a negative example, as machine learning for estimating the effect of recommending objects. The third object group is an object group that is recommended to a user and is not selected by the user. As a result of executing this operation, the processor 111 excludes objects that are not likely to be selected when they are recommended from a group of objects to be recommended to this user.

If the selected object group is the fourth object group, the processor 111 determines that an object to be randomly selected from the fourth object group will be rated as a positive example with a smaller weight than that for the first object group, as previously determined.

That is, the processor 111 is an example of a processor that categorizes objects into plural object groups including a fourth object group and rates the fourth object group as a positive example with a smaller weight than that for the first object group, as machine learning for estimating the effect of recommending objects. The fourth object group is an object group that is not recommended to a user and is not selected by the user.

The processor 111 stores features for evaluating objects and users in the memory 112. The feature qᵢ of an object and the feature pᵤ of a user are each represented by a vector including n elements, for example. The evaluation value vᵤᵢ for a combination of an object and a user is calculated by the inner product of the feature of the object and that of the user. That is, the evaluation value vᵤᵢ is expressed by the following equation (1) using the feature qᵢ of the object and the feature pᵤ of the user.

vᵤᵢ=qᵢ^{T}pᵤ (1)

The processor 111 calculates the evaluation value vᵤᵢ for a combination of the user randomly selected in step S201 and an object to be randomly selected in step S204. If the processor 111 has determined in step S203 that this object will be rated as a positive example, it updates the feature qᵢ and the feature pᵤ so as to increase the evaluation value vᵤᵢ. If the processor 111 has determined in step S203 that this object will be rated as a negative example, it updates the feature qᵢ and the feature pᵤ so as to decrease the evaluation value vᵤᵢ. This type of learning is called learning to rank (LTR) using the pointwise approach, for example.

In step S204, the processor 111 randomly selects one of the objects in the object group selected in step S202. In step S205, the processor 111 calculates the weighting coefficient for the selected object. In step S206, the processor 111 updates the evaluation value for the combination of the user randomly selected in step S201 and the object randomly selected in step S204 by using the calculated weighting coefficient and in accordance with whether the object is a positive value or a negative value. The feature qᵢ and the feature pᵤ are updated according to the following expressions (2), for example:

$${p}_{u} ← {p}_{u} - {w}_{u i} η \frac{\partial L}{\partial {p}_{u}} \\ {q}_{i} ← {q}_{i} - {w}_{u i} η \frac{\partial L}{\partial {q}_{i}} \qquad ( 2 )$$

where η is a learning rate and wᵤᵢ is a weight for a combination of the user represented by u (that is, the user selected in step S201) and the object represented by i (that is, the object selected in step S204).

After updating the evaluation value in step S206, the processor 111 judges in step S207 whether the learning satisfies a converging condition. For example, after updating the evaluation values for all the combinations of the users and the objects, the processor 111 calculates the difference between the updated evaluation value and the previous evaluation value and then adds the absolute values of the calculated differences for all the combinations. If the total absolute value is smaller than a threshold, the processor 111 determines that the learning satisfies the converging condition.

As the converging condition, the following condition 1 or condition 2 may be used.

(Condition 1) The information processing apparatus 1 divides history data into learning data and evaluation data in advance. The processor ill evaluates a model obtained by conducting learning with the learning data by using the evaluation data. That is, the processor 111 performs evaluations, not by learning step, but every time it has updated the evaluation values a certain number of times, such as 1000 times. When an improvement in the evaluation values has become a certain value or lower or the evaluation values have started to decrease, the processor 111 judges that learning has converged.
(Condition 2) The processor ill monitors a change in a parameter by learning step, and when this change has become a certain value or lower, the processor 111 judges that learning has converged. For example, every time learning has proceeded 1000 steps, the processor 111 monitors a difference in the feature pᵤ, and when the absolute value of the difference has become a certain value or lower, the processor 111 judges that learning has converged.

If the processor 111 has judged in step S207 that the learning does not satisfy the converging condition (NO in step S207), it returns to step S201. If the processor 111 has judged that the learning satisfies the converging condition (YES in step S207), the processor 111 stores a matrix of the updated evaluation values in the storage 12 as the learning data 122 in step S208.

### (Predicting)

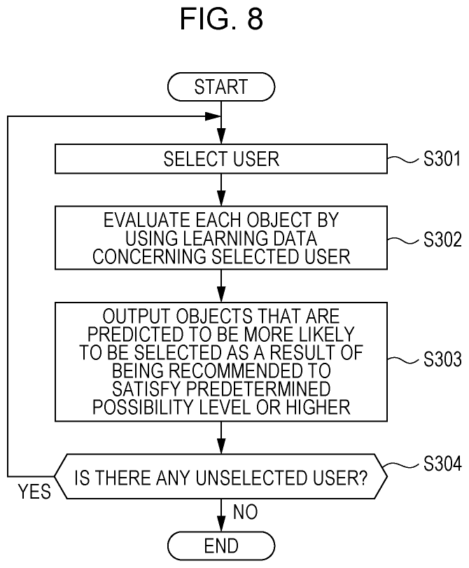

FIG. 8 is a flowchart illustrating an example of the predicting operation executed by the information processing apparatus 1. In step S301, the processor 111 of the controller 11 selects a user in the user list 1211. In step S302, the processor 111 then reads the learning data 122 including information concerning the evaluation values generated in the above-described learning operation from the storage 12, and evaluates multiple objects by using the learning data concerning the selected user. In this case, the processor 111 evaluates the objects in terms of the degree representing how much the possibility of the user selecting the objects will be increased as a result of recommended them.

In step S303, the processor 111 ranks the multiple objects based on the evaluations made in step S302 and extracts objects that are predicted to have the above-described degree that satisfies a predetermined possibility level or higher. The processor 111 then outputs information concerning the extracted objects.

In step S304, the processor 111 judges whether there is any unselected user in the user list 1211. If there is any unselected user (YES in step S304), the processor 111 returns to step S301. If there is no unselected user in the user list 1211 (NO in step S304), the processor 111 completes this processing.

As a result of executing the categorizing, learning, and predicting operations as described above, the processor 111 outputs, for each user, objects that are predicted to be more likely to be selected by the user as a result of being recommended so as to satisfy a predetermined possibility level or higher. The information processing apparatus 1 then recommends the objects output by the processor 111 to the user.

### MODIFIED EXAMPLES

The above-described exemplary embodiment may be modified as follows. The following modified examples may be combined with each other.

### First Modified Example

In the above-described exemplary embodiment, an item is used as an example of an object, advertising an item is an example of recommending an object, and purchasing an item is an example of selecting an object. However, examples of an object, recommending an object, and selecting an object are not restricted to those in the exemplary embodiment. For example, the information processing apparatus 1 may assume adding an item to a cart and registering an item in a wish list as selecting an object. Adding an item to a cart refers to storing an item in a virtual store for eventual purchase by using user's identification information. Registering an item in a wish list refers to storing an item that a user wishes to receive as a present in a list, for example.

The information processing apparatus 1 may recommend another user as a friend to a social network service (SNS) user. In this case, the user recommended by the information processing apparatus 1 is an example of an object. Registering the recommended user as a friend by the SNS user is an example of selecting an object.

The information processing apparatus 1 may recommend a uniform resource identifier (URI) representing a storage location of an article in a news site to a user as an object. In this case, clicking the recommended URI and reading the article or registering the URI in a bookmark is an example of selecting an object.

### Second Modified Example

In the above-described exemplary embodiment, the processor 111 rates objects as a positive example or a negative example by object group. However, the processor ill may rate an object by changing the weight to be applied to this object in accordance with the type of recommendation made to this object. The type of recommendation refers to how big, how often, and in which manner the object has been recommended.

For example, if an item as an object is advertised by using 20% of the display screen of the terminal 2, the processor 111 may apply a larger weighting coefficient to this item than when the item is advertised by using 10% of the display screen.

If an item is advertised at a discount price, the processor 111 may change the weighting coefficient to be applied to this item in accordance with the discount rate.

The processor 111 may change the weighting coefficient to be applied to an item in accordance with how many times this item is advertised per day or the number of other items advertised together with this item. If an item is advertised as video or sound, the processor ill may change the weighting coefficient to be applied to the item in accordance with how long it takes time to view or listen to the advertisement of this item.

The processor 111 may change the weighting coefficient to be applied to an item in accordance with whether the item is advertised only with characters or includes images or video or in accordance with whether it involves a special performance, such as blinking or animated graphics.

That is, the machine learning conducted by the processor 111 is an example of machine learning for rating, among multiple object groups, an object group recommended to a user by changing a weight to be applied to an object categorized as the object group in accordance with the type of recommendation made to the object.

### Third Modified Example

The processor 111 may rate an object by changing the weight to be applied to this object in accordance with the type of selection made for this object by a user. The type of selection refers to how big, how often, and in which manner the object has been selected.

For example, if a user has purchased three pieces of a certain item, the processor 11 may apply a larger weighting coefficient to this item than when the user has purchased only a single piece of this item.

The processor 111 may change the weighting coefficient to be applied to an item depending on how a user has selected this item, such as having purchased the item, having added the item to a cart, or having registered the item in a wish list.

That is, the machine learning conducted by the processor 111 is an example of machine learning for rating, among multiple object groups, an object group selected by a user by changing a weight to be applied to an object categorized as the object group in accordance with the type of selection made to the object.

### Fourth Modified Example

In the above-described exemplary embodiment, an object recommended to a user and selected by the user is categorized as the first object group, and the processor 111 rates an object categorized as the first object group as a positive example. However, the processor 111 may rate an object categorized as the first object group by changing the weight to be applied to this object in accordance with the period of time from when the object is recommended until when it is selected.

For example, for an item purchased by a user within thirty minutes after it is advertised, the processor 111 may rate this item by using a larger weighting coefficient than that to an item purchased in eight hours after it is advertised.

That is, the machine learning conducted by the processor 111 is an example of machine learning for rating the first object group by changing a weight to be applied to an object categorized as the first object group in accordance with the time from when the object is recommended until it is selected.

### Fifth Modified Example

In the above-described exemplary embodiment, the recommendation history and the selection history stored in the history DB 121 are not provided by time period. The storage 12 of the information processing apparatus 1 may alternatively store recommendation histories and selection histories by time period.

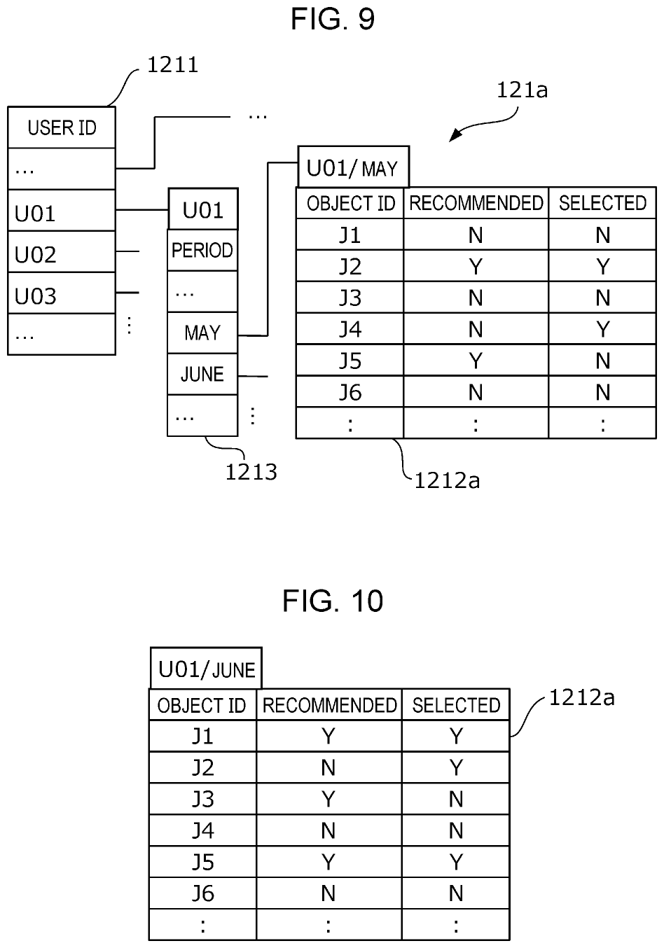

In the fifth modified example, the storage 12 stores a history DB 121a and the memory 112 stores characteristic information 1121a. FIG. 9 illustrates an example of the history DB 121a. The history DB 121a includes a user list 1211, a history table 1212a, and a period list 1213.

The user list 1211 is similar to that shown in FIG. 3, and stores user IDs. The period list 1213 is a list of periods during which predetermined objects are recommended to a user. For each period in the period list 1213, objects to be recommended to a user are determined and are not changed during the same period. In the period list 1213 shown in FIG. 9, character strings representing periods, such as “May” and “June”, are stored.

For each user described in the user list 1211 and for each period described in the period list 1213, the server device determines objects to be recommended to the user. The history table 1212a is generated for each combination of a user ID stored in the user list 1211 and a period stored in the period list 1213. The history table 1212a stores, for each user ID stored in the user list 1211, a recommendation history and a selection history concerning objects judged by the user identified by the user ID during one of the periods described in the period list 1213 whether to select the objects. The history table 1212a shown in FIG. 9 stores a recommendation history and a selection history concerning objects judged by the user identified by “U01” in “May”.

FIG. 10 illustrates an example of the history table 1212a during a different period. The history table 1212a shown in FIG. 10 stores a recommendation history and a selection history concerning objects judged by the user identified by “U01” in “June”. The history table 1212a shown in FIG. 10 is different from that in FIG. 9.

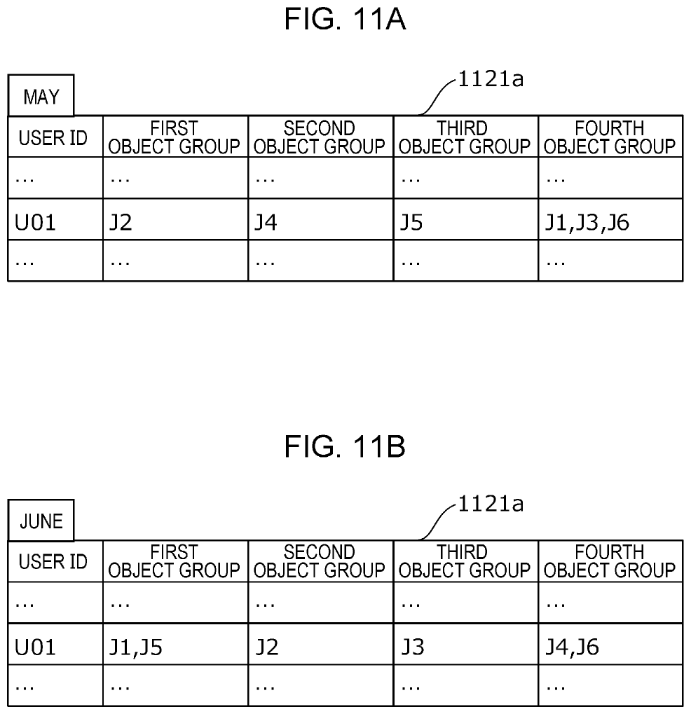

The processor 111 categorizes objects, based on the recommendation histories and selection histories during these different periods. FIGS. 11A and 11B illustrate examples of characteristic information 1121a. The characteristic information 1121a shown in FIG. 11A and that in FIG. 11B are different from the characteristic information 1121 in FIG. 5 in that the characteristic information 1121a is generated for each period described in the period list 1213.

The processor 111 reads the history DB 121a copied into the memory 112 and categorizes, by user and by period, the objects viewed by a certain user during a certain period into the above-described four object groups so as to generate the characteristic information 1121a shown in FIG. 11A and that in FIG. 11B.

For example, the characteristic information 1121a shown in FIG. 11A is information generated based on the recommendation history and the selection history concerning “May”. In the characteristic information 1121a in FIG. 11A, for the user ID “U01”, the objects categorized as the first through fourth object groups are similar to those in the characteristic information 1121 in FIG. 5.

The characteristic information 1121a shown in FIG. 11B is information generated based on the recommendation history and the selection history concerning “June”. In the characteristic information 1121a shown in FIG. 11B, for the user ID “U01”, the object IDs “J1” and “J5” are categorized as the first object group, the object ID “J2” is categorized as the second object group, the object ID “J3” is categorized as the third object group, and the object IDs “J4” and “J6” are categorized as the fourth object group.

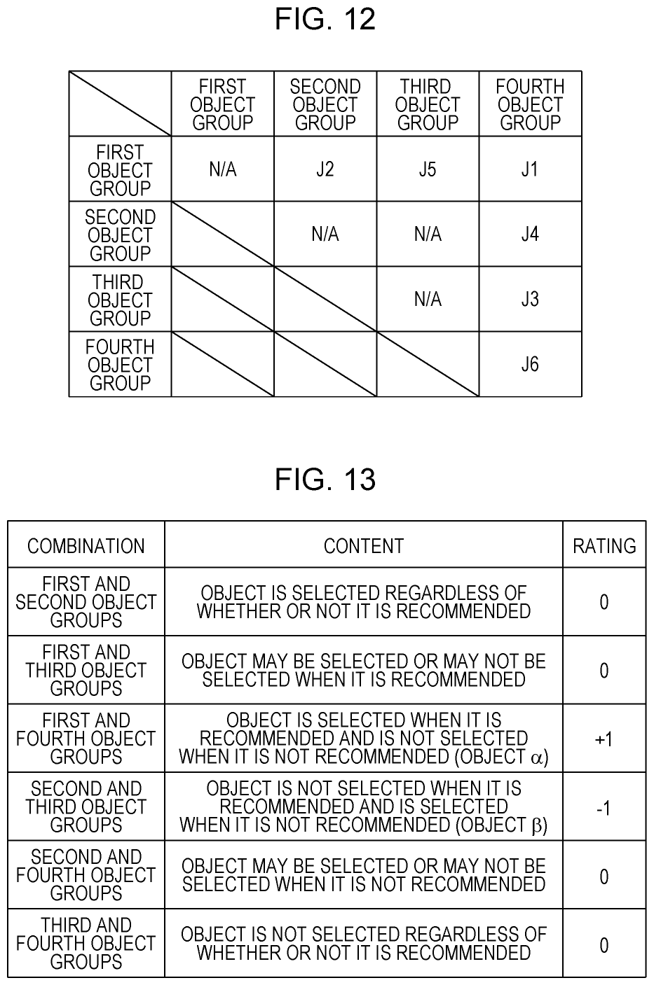

The processor ill analyzes the characteristic information 1121a for the two periods shown in FIGS. 11A and 11B and identifies, for each object, a combination regarding whether the object is recommended and whether the object is selected. FIG. 12 is a table illustrating the result of categorizing the objects judged by a user during different periods. As shown in FIG. 12, based on the histories stored in the storage 12 during the two different periods, each object is categorized as one of the object groups twice, and some objects may be categorized as different object groups.

For example, FIG. 12 shows that the object ID “J1” is categorized as the first and fourth object groups from May to June, and the object ID “J2” is categorized as the first and second object groups from May to June.

FIG. 13 is a table illustrating the combinations of object groups and ratings therefor. If objects are categorized into four object groups during each of two different periods, ten combinations of object groups are generated, as shown in FIG. 12. In these combinations, repetitions are allowed.

Among the ten combinations, four combinations represent a case in which an object is categorized as the same object group during the two periods. Less information is obtained from these cases than from the other cases. These four combinations are thus excluded, and as a result, six combinations are left, as shown in FIG. 13. In these combinations, repetitions are not allowed.

If an object is categorized as the first and second object groups during two different periods, this object may have a characteristic in which it is selected regardless of whether or not it is recommended. Hence, it is difficult to say that the possibility of the object being selected by a user is increased or decreased as a result of recommending the object. The processor 111 of the information processing apparatus 1 thus rates this object as 0.

If an object is categorized as the third and fourth object groups during two different periods, this object may have a characteristic in which it is not selected regardless of whether or not it is recommended. Hence, it is difficult to say that the possibility of the object being selected by a user is increased or decreased as a result of recommending the object. The processor 111 of the information processing apparatus 1 thus rates this object as 0.

If an object is categorized as the first and third object groups during two different periods, this object may have a characteristic in which, when it is recommended, it may be selected or may not be selected. Hence, it is difficult to say that the possibility of the object being selected by a user is increased or decreased as a result of recommending the object. The processor 111 of the information processing apparatus 1 thus rates this object as 0.

If an object is categorized as the second and fourth object groups during two different periods, this object may have a characteristic in which, when it is not recommended, it may be selected or may not be selected. Hence, it is difficult to say that the possibility of the object being selected by a user is increased or decreased as a result of recommending the object. The processor 111 of the information processing apparatus 1 thus rates this object as 0.

If an object is categorized as the first and fourth object groups during two different periods, this object may have a characteristic in which it is selected when it is recommended and it is not selected when it is not recommended. This object is the above-described object α. It is thus possible to say that the possibility of the object being selected by a user is increased as a result of recommending the object. The processor 111 of the information processing apparatus 1 thus rates this object as +1.

That is, the machine learning conducted by the processor 111 is an example of machine learning for categorizing objects into plural object groups and for rating an object group which is recommended to a user and is selected by the user during a certain period and which is not recommended to the user and is not selected by the user during another period as a positive example.

If an object is categorized as the second and third object groups during two different periods, this object may have a characteristic in which it is not selected when it is recommended and it is selected when it is not recommended. This object is the above-described object β. It is thus possible to say that the possibility of the object being selected by a user is decreased as a result of recommending the object. The processor 111 of the information processing apparatus 1 thus rates this object as −1.

That is, the machine learning conducted by the processor 111 is an example of machine learning for rating an object group which is recommended to a user and is not selected by the user during a certain period and which is not recommended to the user and is selected by the user during another period as a negative example.

In this manner, the processor 111 categorizes objects, based on selection histories and recommendation histories during two different periods. If a categorized object is predicted to be the object α, the processor 111 rates this object as a positive value. This makes it more likely for the information processing apparatus 1 to output “objects that are predicted to be more likely to be selected by a user as a result of being recommended”.

If a categorized object is predicted to be the object β, the processor 111 desirably rates this object as a negative value. This makes it less likely for the information processing apparatus 1 to output “objects that are predicted to be less likely to be selected by a user as a result of being recommended”.

### Sixth Modified Example

In the fifth modified example, the processor 111 categorizes objects into different object groups based on recommendation histories and selection histories during different periods, and then rates each object in accordance with into which combination of object groups the object is categorized. The processor 111 may alternatively integrate (merge) recommendation histories and selection histories during different periods. In this case, the processor 111 may determine a weighting coefficient for each object group in accordance with how often objects are categorized as the object group.

If the processor 111 reads recommendation histories and selection histories during different periods from the memory 112, it may rate individual objects for each period. In this case, even though the effect of recommending objects changes among the different periods, the information processing apparatus 1 outputs information concerning objects to be recommended as of each period.

### Seventh Modified Example

In the above-described exemplary embodiment, the processor 111 calculates the evaluation value vᵤᵢ for a combination of a randomly selected object and a randomly selected user according to equation (1). If the user or the object to be selected changes over time, the evaluation value may be calculated according to the following equation (3).

vᵤᵢ(t)=(qᵢ^{S}+qᵢ^{D}(t))·pᵤ^{S}+pᵤ^{D}(t)) (3)

In equation (3), S(static) is a feature component which does not change over time, and D(dynamic) is a feature component which changes over time.

### Eighth Modified Example

Although the processor 111 conducts LTR using the pointwise approach in the above-described exemplary embodiment, it may conduct machine learning using another approach. For example, the processor 111 may conduct LTR using the pairwise approach. In this case, the processor ill updates the feature of an object and that of a user so as to increase the difference xᵤᵢⱼ expressed by the following equation (4).

xᵤᵢⱼ=vᵤᵢ−vᵤⱼ (4)

In equation (4), the subscript i is a combination of an object and a user rated as a positive example, while the subscript j is a combination of an object and a user rated as a negative example. That is, the difference xᵤᵢⱼ in equation (4) represents the difference between the evaluation value of a positive example and that of a negative example. As a result of executing the updating operation in the eighth modified example, an object that is more likely to be selected when it is recommended is more likely to be output, while an object that is less likely to be selected when it is recommended is less likely to be output.

### Ninth Modified Example

In the above-described exemplary embodiment, the controller 11 including the processor 111 and the memory 112 controls the individual elements of the information processing apparatus 1. The information processing apparatus 1 may alternatively include a different type of controller. For example, the information processing apparatus 1 may include the following processors other than a CPU.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

### Tenth Modified Example

In the embodiment above, the term “processor” is broad enough to encompass one processor (such as the processor 111) or plural processors in collaboration which are located physically apart from each other but may work cooperatively. The order of operations of the processor is not limited to one described in the embodiment above, and may be changed.

### Eleventh Modified Example

A program executed by the processor 111 of the controller 11 of the above-described information processing apparatus 1 is an example of a program causing a processor to execute the following process. The processor reads information from a memory. The memory stores, for each object judged by a user whether to select it, a selection history indicating whether the user has selected the object and a recommendation history indicating whether the object has been recommended to the user. The process includes: conducting machine learning for estimating an effect of recommending each object from the selection history and the recommendation history; and outputting, based on a result of the machine learning, information concerning an object that is predicted to be more likely to be selected by the user as a result of being recommended so as to satisfy a predetermined possibility level or higher. This program may be provided as a result of being recorded in a computer readable recording medium, such as a magnetic recording medium (magnetic tape and a magnetic disk, for example), an optical recording medium (an optical disc, for example), a magneto-optical recording medium, or a semiconductor memory. This program may be downloaded via a communication network, such as the internet.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory that stores, for each object judged by a user whether to select the object, a selection history indicating whether the user has selected the object and a recommendation history indicating whether the object has been recommended to the user; and
a processor that reads information from the memory,
the processor configured to
conduct machine learning for estimating an effect of recommending each object from the selection history and the recommendation history, and
output, based on a result of the machine learning, information concerning an object that is predicted to be more likely to be selected by the user as a result of being recommended so as to satisfy a predetermined possibility level or higher.

2. The information processing apparatus according to claim 1, wherein the machine learning categorizes objects into a plurality of object groups including a first object group and a second object group and rates the first object group as a positive example and the second object group as a negative example, the first object group being an object group which is recommended to a user and is selected by the user, the second object group being an object group which is not recommended to a user and is selected by the user.

3. The information processing apparatus according to claim 2, wherein the machine learning categorizes objects into the plurality of object groups including a third object group and rates the third object group as a negative example, the third object group being an object group which is recommended to a user and is not selected by the user.

4. The information processing apparatus according to claim 2, wherein the machine learning categorizes objects into the plurality of object groups including a fourth object group and rates the fourth object group as a positive example with a smaller weight than a weight for the first object group, the fourth object group being an object group which is not recommended to a user and is not selected by the user.

5. The information processing apparatus according to claim 3, wherein the machine learning categorizes objects into the plurality of object groups including a fourth object group and rates the fourth object group as a positive example with a smaller weight than a weight for the first object group, the fourth object group being an object group which is not recommended to a user and is not selected by the user.

6. The information processing apparatus according to claim 2, wherein the machine learning rates, among the plurality of object groups, an object group recommended to a user by changing a weight to be applied to an object categorized as the object group in accordance with a type of recommendation made to the object.

7. The information processing apparatus according to claim 3, wherein the machine learning rates, among the plurality of object groups, an object group recommended to a user by changing a weight to be applied to an object categorized as the object group in accordance with a type of recommendation made to the object.

8. The information processing apparatus according to claim 4, wherein the machine learning rates, among the plurality of object groups, an object group recommended to a user by changing a weight to be applied to an object categorized as the object group in accordance with a type of recommendation made to the object.

9. The information processing apparatus according to claim 2, wherein the machine learning rates, among the plurality of object groups, an object group selected by a user by changing a weight to be applied to an object categorized as the object group in accordance with a type of selection made to the object.

10. The information processing apparatus according to claim 3, wherein the machine learning rates, among the plurality of object groups, an object group selected by a user by changing a weight to be applied to an object categorized as the object group in accordance with a type of selection made to the object.

11. The information processing apparatus according to claim 4, wherein the machine learning rates, among the plurality of object groups, an object group selected by a user by changing a weight to be applied to an object categorized as the object group in accordance with a type of selection made to the object.

12. The information processing apparatus according to claim 6, wherein the machine learning rates, among the plurality of object groups, an object group selected by a user by changing a weight to be applied to an object categorized as the object group in accordance with a type of selection made to the object.

13. The information processing apparatus according to claim 2, wherein the machine learning rates the first object group by changing a weight to be applied to an object categorized as the first object group in accordance with a time from when the object is recommended until the object is selected.

14. The information processing apparatus according to claim 3, wherein the machine learning rates the first object group by changing a weight to be applied to an object categorized as the first object group in accordance with a time from when the object is recommended until the object is selected.

15. The information processing apparatus according to claim 4, wherein the machine learning rates the first object group by changing a weight to be applied to an object categorized as the first object group in accordance with a time from when the object is recommended until the object is selected.

16. The information processing apparatus according to claim 6, wherein the machine learning rates the first object group by changing a weight to be applied to an object categorized as the first object group in accordance with a time from when the object is recommended until the object is selected.

17. The information processing apparatus according to claim 9, wherein the machine learning rates the first object group by changing a weight to be applied to an object categorized as the first object group in accordance with a time from when the object is recommended until the object is selected.

18. The information processing apparatus according to claim 1, wherein the machine learning categorizes objects into a plurality of object groups and rates an object group which is recommended to a user and is selected by the user during a certain period and which is not recommended to the user and is not selected by the user during another period as a positive example.

19. The information processing apparatus according to claim 1, wherein the machine learning rates an object group which is recommended to a user and is not selected by the user during a certain period and which is not recommended to the user and is selected by the user during another period as a negative example.

20. A non-transitory computer readable medium storing a program causing a processor to execute a process, the processor reading information from a memory that stores, for each object judged by a user whether to select the object, a selection history indicating whether the user has selected the object and a recommendation history indicating whether the object has been recommended to the user, the process comprising:
conducting machine learning for estimating an effect of recommending each object from the selection history and the recommendation history; and
outputting, based on a result of the machine learning, information concerning an object that is predicted to be more likely to be selected by the user as a result of being recommended so as to satisfy a predetermined possibility level or higher.
